(19) United States
(12) Patent Application Publication
(10) Pub. No.: US 2011/0050389 A1
(43) Pub. Date: Mar. 3, 2011

(54) LOW POWER WIRELESS CONTROLLER SYSTEMS AND METHODS

(75) Inventors: James Robert Kruest, San Diego, CA (US); Paul Atkinson, Poway, CA (US)

(73) Assignee: AEQUITAS Innovation, Poway, CA (US)

(21) Appl. No.: 12/843,644

(22) Filed: Jul. 26, 2010

Related U.S. Application Data
(60) Provisional application No. 61/228,600, filed on Jul. 26, 2009.

(51) Int. Cl. G05B 19/00; H04Q 5/22

(52) U.S. Cl. 340/5.8; 340/10.1

(57) ABSTRACT

A wireless control device is described that single chip passive wireless control integrated circuit device. The device is coupled to an antenna configured to receive a radio signal and comprises a radio frequency transceiver circuit fabricated on a semiconductor substrate of an integrated circuit device and configured to extract information from the radio signal and a processor fabricated on the semiconductor substrate and configured to receive the information extracted from the radio signal and to respond to a command encoded in the information. A FET fabricated on the substrate operates as a switch and has a gate controlled by the processor. The FET can be configured to transmit an activation current provided to the integrated circuit device to an output of the integrated circuit device. The output may drive an actuator.

### CROSS-REFERENCE TO RELATED APPLICATIONS

The present application claims priority from U.S. Provisional Patent Application No. 61/228,600 filed Jul. 26, 2009, which is expressly incorporated by reference herein.

### BACKGROUND OF THE INVENTION

1. Field of the Invention

The present invention relates generally to security systems for controlling commercial merchandise.

2. Description of Related Art

Wireless identification systems are used for inventory control purposes and, most commonly, to recognize and locate items of inventory at point of sale and/or exits of a commercial establishment. Wireless controllers are sometimes used for controlling the operation of a device peripheral to the wireless controller and in particular applications where the devices comprise small, low powered electro-mechanical locks. Existing wireless controllers are bulky and costly devices, comprised of numerous components, and require a source of power to operate in excess of that available from passive a low power RF field such as that generated in radio frequency identification (“RFID”) systems. Conventional controllers generally comprise printed circuit boards with discrete components and easily accessible electrical traces and connections. This makes them too large and too costly for many applications and also renders them susceptible to attack because the traces and connectors can be easily disrupted or used to trigger unauthorized actions. Further, they require a source of power to operate beyond that available from a low power RF field.

### BRIEF SUMMARY OF THE INVENTION

The above described limitations and other limitations of the prior art are overcome in systems constructed according to certain aspects of the invention. Certain embodiments of the invention provide a passive wireless control integrated circuit device that may comprise an antenna configured to receive a radio signal, a radio frequency transceiver circuit fabricated on a semiconductor substrate of an integrated circuit device and configured to extract information from the radio signal and a processor fabricated on the semiconductor substrate and configured to receive the information extracted from the radio signal and to respond to a command encoded in the information. Some of these embodiments comprise a FET fabricated on the substrate.

In some of these embodiments, the FET is operable as a switch and has a gate controlled by the processor. The FET can be configured to transmit an activation current provided to the integrated circuit device to an output of the integrated circuit device in response to an activation signal from the processor. The transceiver and processor are powered using energy extracted from radio signals received by the antenna. The activation current typically exceeds 40 milliamps and the current delivers power at a rate that is an order of magnitude greater than the power available to operate the circuits on the integrated circuit.

Some of these embodiments comprise a storage and the information may be authenticated by a password maintained in the storage and or decrypted using an encryption key maintained in the storage. In some of these embodiments, the information comprises a command that causes the processor to generate the activation signal. The FET typically transmits current provided by a battery and/or a charge storage device to the output of the integrated circuit device. The information may also comprise a command that causes the processor to generate a deactivation signal. In some of these embodiments, the FET is configured to block an activation current provided to the integrated circuit device in response to the deactivation signal.

In some of these embodiments, the activation current is provided to an actuator external to the integrated circuit device. In some of these embodiments, the actuator is operable to mechanically disable a feature of an item. In some of these embodiments, the activation current is provided to one of a source and a drain of the FET. In some of these embodiments, the output of the integrated circuit device is coupled to the other of the source and drain of the FET. Some of these embodiments comprise a test circuit connected in parallel with the source and the drain. In some of these embodiments, the test circuit includes a second FET. In some of these embodiments, the second FET has a gate controlled by the processor. In some of these embodiments, the second FET is configured to transmit a test current to the output of the integrated circuit device in response to a test signal received from the processor. In some of these embodiments, the test current has a lower amperage than the activation current. In some of these embodiments, the test current is provided to the actuator. In some of these embodiments, the amperage of the test current is less than a threshold amperage required to actuate the actuator.

### BRIEF DESCRIPTION OF THE DRAWINGS

FIG. 1 is a schematic of a wireless transceiver interface to LED controls according to certain aspects of the invention.

FIG. 2 is a schematic showing components of a single chip wireless controller according to certain aspects of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

Certain embodiments of the invention provide systems and methods for implementing a very low cost “passive” wireless controller for controlling the operation of a device peripheral to a wireless controller. The wireless controller can be used for controlling the operation of the peripheral device using small, low powered electro-mechanical locks. The wireless controller may be embodied in a low power device, such as an RFID. In certain embodiments, the peripheral device requires higher power to operate than can be provided by the wireless controller. In the RFID example, the RFID operates using a small amount of energy incident in a RF field, typically produced by an RFID reader, and can provide insufficient power to drive the peripheral device. Certain devices constructed according to certain aspects of the presently described invention can be incorporated in, or used with, wireless controllers that control peripheral devices that may include low powered electro-mechanical locks.

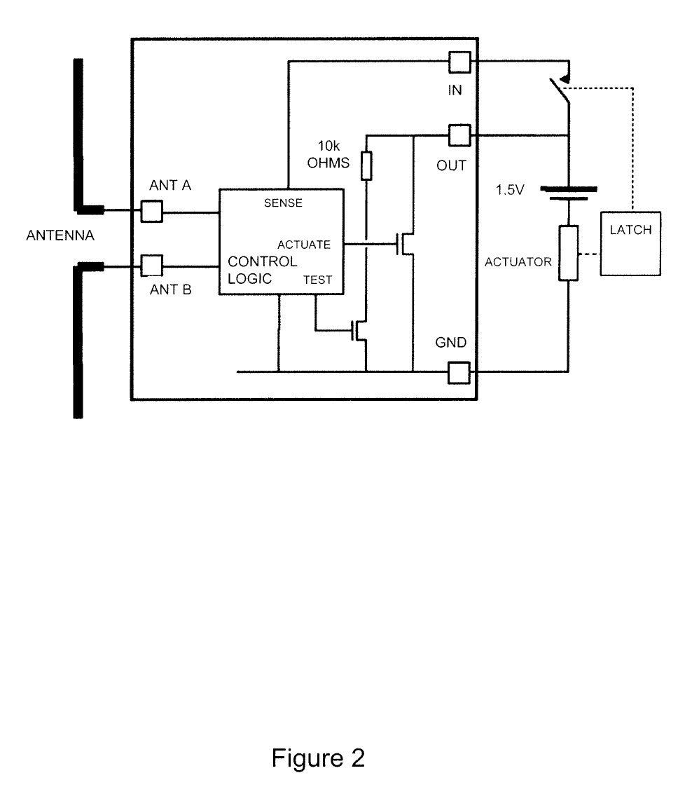

Certain embodiments of the invention provide a low power, low cost wireless controller and related systems suitable for controlling an item. The example depicted in FIG. 2 shows an embodiment in which the wireless controller is provided in a single chip 20 that comprises a transceiver of controller 200 suitable for transmitting and receiving wireless communications using an antenna 21 that may be disposed on the chip 20, fabricated on the chip 20, painted on the chip 20 or located apart from, or proximately to the chip 20. The wireless communications may facilitate an exchange of information, typically according to a standards-based transmission protocol that may specify formats for transmitting the information. The information may include command and data elements and the protocol may specify sequences for exchange of passwords, encryption keys and other identifying information. The commands and data may include information that caused the wireless controller to control a power source required to drive an actuator, or otherwise operate a locking device or other peripheral. The password or key may be used to authenticate the wireless communications. In some embodiments, communications may be unauthenticated and the password or key may permit one or more specific actions or events to occur within the wireless controller 200.

In certain embodiments, the wireless controller 200 is a passive device that does not include its own power source, but is instead powered by small amounts of energy incident in the RF field generated by a transceiving base station, such as an RFID reader. The wireless controller 200 receives communications through an antenna 21 that is coupled to a transceiver portion of the wireless controller 200 and is typically located in the chip 20. An interface portion 220 of the wireless controller 200 provides one or more signals used to control aspects of operation of an actuator 24. The actuator 24 may operate at significantly greater power levels than the wireless controller 200 can supply and the actuator 24 may be coupled to an external battery 22 or other power source. Current from the power source 22 may be controlled through FET 202 using an activation signal 222 from controller 200. The power required to operate actuator 24 may be at least one order of magnitude greater than the power required to operate controller 200 and/or the power obtained from radio signals received by antenna 21.

In certain embodiments, wireless communications are received and handled separately from the interface to the actuator 24 that controls and/or protects an item such as an item of merchandise. The wireless controller 200 may receive an authenticated communication from an antenna 21 coupled to the wireless controller 200 through a set of contacts 210 on an integrated circuit device. In one example, the set of contacts 210 includes an antenna input and a ground signal used as a reference voltage. In another example, the set of contacts 210 includes antenna differential inputs 211 and 212 as shown in FIG. 2. One or more other sets of contacts 240 and 250 may be provided to interface with an actuator 24. The interface to the actuator 24 may provide and/or receive signals used to determine, monitor and/or confirm the current state or condition of the actuator. In the example of FIG. 2, signals provided through pads 242 and 243 may be used to drive the actuator 24, while pad 241 is used to sense status of the actuator 24 and/or a latch 25, armature, axle, rotor or other movable element. In the example of FIG. 2, sensing is accomplished using one or more contacts/switches 26 to determine current location and/or rotation of at least a portion of latch 25 or armature, etc.

As shown in FIG. 2, a test current may be provided to actuator 24 using FET 204 limited by impedance 205, which is typically resistive. The interface to the actuator 24 may comprise a digital data bus having one or more data lines. Signals may comprise output signals, input signals and/or bidirectional signals. Signals may be configured to control the flow of current through a switch or relay. Signals may be configured to carry a current controlled by a switch or relay.

In certain embodiments, a wireless controller can be constructed as a single integrated circuit chip. The integrated circuit may be provided on a semiconductor substrate using standard integrated circuit manufacturing methods, such as CMOS. A wireless controller device fabricated on a single chip integrated circuit according to certain aspects of the invention can occupy less space than an equivalent circuit implemented on a printed circuit board and comprising discrete devices. Accordingly, a device according to certain aspects of the invention can be more easily incorporated into very small devices such as wireless locking mechanisms. Furthermore, the use of a single chip controller eliminates traces and contacts that are vulnerable to bypass or attack commonly seen with conventional wireless controllers.

In certain embodiments, the wireless transceiver communicates by RF operating in the range of 900 MHz (UHF) utilizing industry standard air interface protocols, including ISO-18000-6 EPC Gen 2 at UHF frequencies, ISO-14443 used for Near Field Communications (NFC) at HF frequencies, ZigBee, Bluetooth, IEEE 802.11x and so on. Other frequencies, standards and protocols may be used, including proprietary protocols.

In certain embodiments, the wireless controller comprises a single chip integrated circuit that includes a switch, such as metal-oxide-semiconductor field effect transistors (“MOSFET” or “FET”). Typically the FETs are designed to accommodate the performance requirements of a specific application and are sized appropriate for the application. Performance requirements can include switching frequency and reliability. As will be appreciated, typical design goals for digital logic design of a wireless controller include minimizing the area of semiconductor (e.g. silicon) occupied by the circuitry for the design specifications and minimizing power consumption of the circuit. Both goals may be served by minimizing the size of transistors according to techniques known to those skilled in the semiconductor arts. Accordingly the area occupied by FETs used in wireless controllers is typically less than a square micrometer and such FETs are typically rated for currents in the range of micro-amps and nano-amps.

In certain embodiments of the invention wireless controllers are fabricated that have a physically large FET incorporated into a digital logic block. In one example, a large FET is provided as part of an RFID chip, where the FET is capable of switching a current in the range of 50 mA to 100 mA. The current is provided by a battery and conducted through source and drain of the FET using externally accessible terminals. The source and drain can be connected to chip bonding pads, while the gate of the FET is interfaced to and controlled by an internal digital circuit. In this “pass-through” configuration the FET performs as a relay/switch having on and off states controlled by the digital logic circuit. Incorporating the FET directly into the wireless controller chip reduces the cost of the wireless controller by eliminating external components and affords a higher level of physical security by eliminating access points to control circuits.

In certain embodiments, a FET fabricated on a wireless controller chip can conduct more than 50 mA of current and may occupy in excess of ten thousand square micrometers of silicon area. The FET may comprise a significant percentage of a typical RFID chip and has heretofore been considered impractical for implementing a control interface due to the increase in the area of a silicon RFID chip and its resultant cost. According to certain aspects of the invention, area occupied by a switching FET may be reduced by evaluating relevant design considerations. Factors appropriate to the application of operating an actuator are typically considered in the design of the FET. In one example, the switching speed of the FET is typically not a critical design concern for applications related to controlling an actuator in a locking device, and switching speed ratings can be significantly relaxed relative to the requirements for other common digital switching logic circuits. Additionally, because the number of actuations in many applications is relatively low—often less than ten cycles—long term reliability requirements can also be relaxed, permitting variances to normal design rules and margins related to electro-migration and peak junction temperatures. In certain embodiments, such tradeoff analysis of the essential and non-essential performance requirements can result in an FET whose size is reduced and optimized for the application.

In certain embodiments, the switching FET is switched between turned fully on and fully off when the switching FET in the wireless controller is used to control battery current to an actuator. When switched on, the full current available from the battery or required by the actuator is transmitted to the actuator. However, certain embodiments provide a mode of operation in which the actuator receives a smaller current than the full current, so that the electrical continuity of the battery, actuator and RFID chip connections can be verified. This limited current mode can be referred to as a “Test Mode.” The Test Mode may be implemented by including a separate FET switch of proportionately smaller size than the switching FET, but sharing the same pad connections as the larger switching FET. Typically, test FET provides the actuator circuit with a test current below the threshold current required for actuation. In one example, the test current is less than one milliamp and, when flowing through the actuator, the test current may be sensed by a current sensing circuit, thereby confirming electrical continuity. Current sensing circuit is typically provided on the single chip wireless controller. Optionally, a resistor in series with the Source or Drain terminal of the small FET can assist in limiting the test current to a desired value.

Certain embodiments provide positive confirmation that the lock mechanism has successfully unlocked as a result of the wireless transaction at the point of sale. Positive confirmation at the time of sale assures consumer confidence that the product will operate as intended. In one example, a moveable element within a locking mechanism is driven by the actuator to a limit or endpoint of its intended travel. Electrical contacts embedded within the lock mechanism may be closed (or opened) when the moveable element of the mechanism has reached the limit or endpoint. Accordingly, these electrical contacts can provide an indication that the actuator has fully actuated or that the latch has fully released. In one example, the battery voltage is connected to an input of the wireless controller device when the electrical contacts are closed. The input may be electrically coupled to a port that is directly readable by a processor of an RFID and/or to an input of a logic gate, an input of a register, an input of an FET or another device that operates to communicate a signal or status to a processor of the wireless controller. The status and/or signal may be communicated to a point of sale terminal for confirmation of a completed action or a failure to complete an action in response to a request or command of the point of sale terminal. In some embodiments, the actuator may be configured such that movement of the actuator, or a latch associated with the actuator, may cause a change in a capacitive element coupled to an input of the wireless controller. In one example, the capacitive element may affect a resonant circuit on the chip such that a change in the resonance point signals that the lock has successfully unlocked. In another example, the capacitive element may affect a time constant of an RC or other circuit, whereby a delay associated with the RC circuit is measurable by a processor of the wireless controller.

In certain embodiments, the wireless controller authenticates a wirelessly transmitted command. In one example, the command may be authenticated using comparative logic that compares a received password or key to a stored value corresponding to the password or key. It can be appreciated that the combination of authentication, physical security afforded by a single chip implementation and enhanced drive capabilities of the novel wireless controllers disclosed herein enables many applications, lowers fabrication and operational costs and improves security by eliminating breach points commonly found in conventional wireless controllers (e.g. contacts and traces). Accordingly, the disclosed invention can be deployed in systems other than inventory control. Examples of such applications may include remotely activated failsafe systems that respond to authenticated commands provided in an RFID interrogation signal to perform initiate shutdown of an engine in a moving vehicle. In another example, portable electronic equipment may be disabled when a wireless controller receives an authenticated command provided in a WiFi signal, a cellular telephone signal, an RFID interrogation signal, or other signal. It will be appreciated that, in the latter example, the portable electronic equipment need not be powered and/or active for disablement to occur and that the wireless controller may additionally respond to interrogation, thereby providing a means for identifying the location of the equipment.

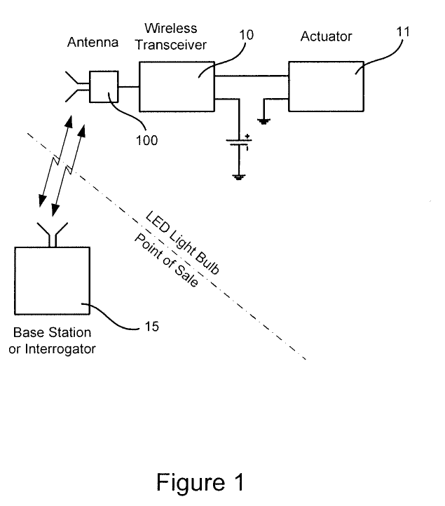

With reference to FIG. 1, a wireless transceiver 10 can be a “passive” device, deriving its power from the incident RF field, but it can also be an “active” device containing its own power supply (not shown), typically comprising some combination of a battery, a capacitor, a photovoltaic cell, etc. The wireless transceiver 10 comprises a “front end” portion capable of transceiving data communications in addition to harvesting power from incident energy sources, such as a radio frequency field or optical radiation. In certain embodiments, the front end comprises an antenna 100. In conventional systems, antenna 100 is provided on a substrate that carries the RFID transceiver circuit. The wireless transceiver 10 also comprises a “back end” interface that drives an actuator 11 capable of controlling an item to be protected.

During the check-out process at a point of sale (“POS”), a wireless communication is initiated between the POS system 15 and the protected product. This communication exchange typically comprises an exchange of identification data and passwords or “keys” and if the pre-established security criteria are met, the transaction authorizes the product to “unlock.” Once unlocked, the product will operate normally for its intended application. Various security schemes may be employed to obtain a desired level of security. In one example, the transaction process may be configured to operate with a “null” password or key where the higher level of security afforded by using a password is not required. In another example, and exchange of information may be required to ensure that the user of the POS is authorized to unlock the merchandise.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. For example, it is contemplated that the techniques and devices described herein may be adapted for use in heavier duty applications and may consequently employ fabrication techniques known to those skilled in the art to provide a specialized FET circuit to drive an actuator or other device; such specialized FET may comprise a power MOSFET, a VMOS FET, a UMOS FET and so on. Certain additional aspects and features of the invention are further set forth below, and can be obtained using the functionalities and components described in more detail above, as will be appreciated by those skilled in the art after being taught by the present disclosure.

Certain embodiments of the invention provide a passive wireless control integrated circuit device. Some of these embodiments comprise an antenna configured to receive a radio signal. Some of these embodiments comprise a radio frequency transceiver circuit fabricated on a semiconductor substrate of an integrated circuit device and configured to extract information from the radio signal. Some of these embodiments comprise a processor fabricated on the semiconductor substrate and configured to receive the information extracted from the radio signal and to respond to a command encoded in the information. Some of these embodiments comprise a FET fabricated on the substrate. In some of these embodiments, the FET is operable as a switch. In some of these embodiments, the FET has a gate controlled by the processor. In some of these embodiments, the FET is configured to transmit an activation current provided to the integrated circuit device to an output of the integrated circuit device in response to an activation signal from the processor. In some of these embodiments, the activation current is generated by a power source that is external to the integrated circuit device. In some of these embodiments, the transceiver and processor are powered using energy extracted from radio signals received by the antenna. In some of these embodiments, the activation current exceeds 40 milliamps.

Some of these embodiments comprise a storage. In some of these embodiments, the information is authenticated by a password maintained in the storage. In some of these embodiments, the information is encrypted. In some of these embodiments, the processor decrypts the information using an encryption key maintained in the storage. In some of these embodiments, the information comprises a command that causes the processor to generate the activation signal. In some of these embodiments, the FET transmits current provided by a battery to the output of the integrated circuit device. In some of these embodiments, the FET transmits current provided by a charge storage device to the output of the integrated circuit device. In some of these embodiments, the information comprises a command that causes the processor to generate a deactivation signal. In some of these embodiments, the FET is configured to block an activation current provided to the integrated circuit device in response to the deactivation signal.

In some of these embodiments, the activation current is provided to an actuator external to the integrated circuit device. In some of these embodiments, the actuator is operable to mechanically disable a feature of an item. In some of these embodiments, the actuator is operable to mechanically control a feature of an item controlled by the integrated circuit device. In some of these embodiments, the activation current is provided to one of a source and a drain of the FET. In some of these embodiments, the output of the integrated circuit device is coupled to the other of the source and drain of the FET. Some of these embodiments comprise a test circuit connected in parallel with the source and the drain. In some of these embodiments, the test circuit includes a second FET. In some of these embodiments, the second FET has a gate controlled by the processor. In some of these embodiments, the second FET is configured to transmit a test current to the output of the integrated circuit device in response to a test signal received from the processor. In some of these embodiments, the test current has a lower amperage than the activation current. In some of these embodiments, the test current is provided to the actuator. In some of these embodiments, the amperage of the test current is less than a threshold amperage required to actuate the actuator.

Certain embodiments of the invention provide systems and methods for wirelessly controlling an item. Some of these embodiments comprise a passive wireless control integrated circuit device. In some of these embodiments, the integrated circuit device includes an antenna. In some of these embodiments, the integrated circuit device includes a radio frequency transceiver circuit fabricated on a semiconductor substrate of the integrated circuit device. In some of these embodiments, the transceiver is configured to extract information from a radio signal received by the antenna. In some of these embodiments, the integrated circuit device includes a processor fabricated on the semiconductor substrate. In some of these embodiments, the processor is configured to receive the information extracted from the radio signal and to respond to an activation command encoded in the information. In some of these embodiments, the integrated circuit device includes one or more FETs fabricated on the substrate and operable as a switch. In some of these embodiments, responsive to the activation command, the processor provides an activation signal to a gate of one of the FETs, thereby causing the FET to enable flow of an activation current through the integrated circuit device.

Some of these embodiments comprise a power source that provides the activation current. Some of these embodiments comprise an actuator configured to change state in response to the activation current. In some of these embodiments, the transceiver and processor are powered using energy extracted from radio signals received by the antenna. In some of these embodiments, the device comprises a sensor that provides a signal indicative of actuator state. In some of these embodiments, the sensor comprises a capacitor having a capacitance that corresponds to a state of the actuator. In some of these embodiments, the sensor comprises electrical contacts embedded within a lock mechanism. In some of these embodiments, the activation command is decrypted from the information using an encryption key maintained in a storage of the integrated circuit device. In some of these embodiments, the activation current is between 50 and 100 mA. In some of these embodiments, the power used to activate the actuator is at least an order of magnitude greater than the power extracted from the radio signals.

Some of these embodiments comprise methods for manufacturing the integrated semiconductor device. Certain embodiments of the invention provide methods for using the device and systems described above.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A passive wireless control integrated circuit device, comprising:
a radio frequency transceiver circuit fabricated on a semiconductor substrate of an integrated circuit device and configured to extract information from a radio signal received by an antenna;
a processor fabricated on the semiconductor substrate and configured to receive the information extracted from the radio signal and to respond to a command encoded in the information; and
a field effect transistor (FET) fabricated on the substrate and operable as a switch, the FET having a gate controlled by the processor, wherein responsive to an activation signal from the processor, the FET is configured to transmit an activation current to an output of the integrated circuit device,
wherein the activation current is generated by a power source that is external to the integrated circuit device and the transceiver and processor are powered using energy extracted from radio signals received by the antenna.

2. The device of claim 1, wherein the power source comprises a battery.

3. The device of claim 1, wherein the power source comprises a charge storage device.

4. The device of claim 1, wherein the device further comprises a storage and wherein the processor is configured to authenticate the information using a password maintained in the storage.

5. The device of claim 4, wherein the information comprises a command that causes the processor to generate the activation signal.

6. The device of claim 4, wherein the activation current is provided to an actuator external to the integrated circuit device, wherein the actuator is operable to mechanically control a feature of an item controlled by the integrated circuit device.

7. The device of claim 6, wherein the activation current is provided by the power source to one of a source and a drain of the FET, and wherein the output of the integrated circuit device is coupled to the other of the source and drain of the FET.

8. The device of claim 7, further comprising a test circuit connected in parallel with the source and the drain of the FET, the test circuit including a second FET having a gate controlled by the processor, wherein responsive to a test signal received from the processor, the second FET is configured to transmit a test current to the output of the integrated circuit device.

9. The device of claim 8, wherein the test current has a lower amperage than the activation current.

10. The device of claim 9, wherein the test current is provided to the actuator and wherein the amperage of the test current is less than a threshold amperage required to actuate the actuator.

11. The device of claim 10, wherein the threshold current exceeds 40 milliamps.

12. The device of claim 1, wherein the information is encrypted and wherein the processor is configured to decrypt the information using an encryption key maintained in a storage of the device.

13. The device of claim 12, wherein the information comprises a command that causes the processor to generate the activation signal.

14. The device of claim 12, wherein the activation current is provided to an actuator external to the integrated circuit device, wherein the actuator is operable to mechanically control a feature of an item controlled by the integrated circuit device.

15. The device of claim 14, wherein the activation current is provided by the power source to one of a source and a drain of the FET, and wherein the output of the integrated circuit device is coupled to the other of the source and drain of the FET.

16. The device of claim 15, further comprising a test circuit, the test circuit including a second FET having a gate controlled by the processor, the second FET being configured to provide a test current to the output of the integrated circuit device in response to a test signal received from the processor.

17. The device of claim 16, wherein the test current has a lower amperage than the activation current.

18. The device of claim 17, wherein the test current is provided to the actuator and wherein the amperage of the test current is less than a threshold amperage required to actuate the actuator.

19. The device of claim 18, wherein the threshold current exceeds 40 milliamps.

20. The device of claim 1, wherein the processor receives one or more signals indicating state of the actuator, wherein the activation signal is provided to cause a change in the state.

21. The device of claim 1, wherein the activation current exceeds 40 milliamps.

22. The device of claim 1, wherein the wireless controller comprises an RFID receiver.

23. A system for wirelessly controlling an item, comprising:
a passive wireless control integrated circuit device that includes
an antenna,
a radio frequency transceiver circuit fabricated on a semiconductor substrate of the integrated circuit device and configured to extract information from a radio signal received by the antenna,
a processor fabricated on the semiconductor substrate and configured to receive the information extracted from the radio signal and configured to respond to an activation command encoded in the information, and
a metal oxide semiconductor field effect transistor (FET) fabricated on the substrate, wherein responsive to the activation command, the processor provides an activation signal to a gate of the FET, thereby causing the FET to enable flow of an activation current through the integrated circuit device;
a power source that provides the activation current; and
an actuator configured to change state in response to the activation current,
wherein the transceiver and processor are powered using energy extracted from radio signals received by the antenna.

24. The system of claim 23, wherein the device comprises a sensor that provides a signal indicative of actuator state.

25. The system of claim 24, wherein the sensor comprises a capacitor having a capacitance that corresponds to a state of the actuator.

26. The system of claim 24, wherein the sensor comprises electrical contacts embedded within a lock mechanism.

27. The system of claim 23, wherein the activation command is decrypted from the information using an encryption key maintained in a storage of the integrated circuit device.
